(19) United States
(12) Patent Application Publication
(10) Pub. No.: US 2026/0148362 A1
(43) Pub. Date: May 28, 2026

(54) DEVICE AND METHOD OF INTEGRATING PRODUCTION LINE DATA AS AUXILIARY DATA FOR ABNORMALITY ANALYSIS

(71) Applicants: SQ Technology (Shanghai) Corporation, Shanghai (CN); Inventec Corporation, Taipei City (TW)

(72) Inventor: Shou-Jun Guo, Shanghai (CN)

(21) Appl. No.: 19/025,326

(22) Filed: Jan. 16, 2025

(30) Foreign Application Priority Data
Nov. 22, 2024 (CN) 2024116909060

(51) Int. Cl. G06T 7/00

(52) U.S. Cl. CPC G06T 7/0004; G06T 2207/30108

(57) ABSTRACT

A device of integrating production line data as auxiliary data for abnormality analysis and a method thereof are disclosed. A repair/repairable system obtains defect repair information generated by an inspection station sited behind an automated optical inspection device and determining that a target material is abnormal, material data of the target material is read based on defect location information from an optical test data sheet generated by integrating an optical inspection data generated by the AOI device and a control management data generated by control management systems on a production line. A component location image is extracted from a material image of the target material based on the defect location information of the defect repair information, and the material data. The defect repair information and the component location image are integrated to generate integration information of the target material.

### CROSS-REFERENCE TO RELATED APPLICATION

This application claims the benefit of Chinese Application Serial No. 2024116909060, filed Nov. 22, 2024, which is hereby incorporated herein by reference in its entirety.

### BACKGROUND OF THE INVENTION

### 1. Field of the Invention

The present invention relates to a device and a method for generating an auxiliary analysis report, and particularly a device of integrating production line data as auxiliary data for abnormality analysis and a method thereof.

### 2. Description of the Related Art

Industry 4.0, also known as the fourth industrial revolution, is about creating new industrial technologies and focuses on integrating existing industrial technologies, sales processes, and product experiences. Artificial intelligence technologies are used to establish smart factories with adaptability, resource efficiency, and human factors engineering, and integrates customers and business partners into business and value processes to provide comprehensive after-sales services, thereby constructing a new perceptive and intelligent industrial world.

As the wave of Industry 4.0 sweeps the globe, manufacturers are optimizing production transformation through smart manufacturing to enhance competitiveness. Smart manufacturing is built on sensing technology, networking technology, automation technology, and artificial intelligence, thereby achieving intelligent product design and manufacturing, enterprise management and services through the processes of perception, human-machine interaction, decision-making, execution, and feedback.

However, the characteristics of the electronics assembly industry, such as thin profit margins and intense price competition, drive manufacturers to pursue more effective control and optimization of raw materials and production tools to maximize production resource efficiency. During the manufacturing of materials on existing the production line, when an inspection station detects an abnormality in the material and performs repair, it is necessary to notify other testing stations set before the inspection station to trace and locate the cause of the abnormality. For example, in an optical inspection station, the existing method, when repair personnel find an abnormal optical inspection result of the material, is that the repair personnel notifies optical inspection test engineers, the test engineers perform qualitative analysis on the repair event of the abnormal material to determine whether the inspection abnormality of the material is related to the testing process of the inspection station, and analyze the reason why this abnormality was not detected.

However, the above abnormality tracing and locating process relies heavily on the personal experience of test engineers and lacks systematic and standardized criteria, and data from different inspection station are not integrated, so it may lead to errors in the test engineers'judgment. Furthermore, the above-mentioned manual analysis process is cumbersome and time-consuming.

According to above-mentioned reasons, what is needed is to develop an improved solution to solve the problem of the abnormality tracing and locating operation on the production line being limited by the personal experience of test engineers and that the independent use of data from inspection station may lead to errors in judgment.

### SUMMARY OF THE INVENTION

An objective of the present invention is to disclose a device of integrating production line data as auxiliary data for abnormality analysis and a method thereof, to solve the problem that the abnormality tracing and locating operation on the production line being limited by the personal experience of test engineers and the independent use of data from inspection station may lead to errors in judgment.

To achieve the objective, the present invention discloses a device of integrating production line data as auxiliary data for abnormality analysis, include a data obtaining module, a data maintenance module, an image extraction module, an information integration module, and an information output module. After a target material is passed through an automated optical inspection (AOI) device disposed on a production line, the data obtaining module is configured to obtain an optical inspection result generated by the AOI device and control management data of the target material generated by control management systems on the production line, and obtain defect repair information through a repair/repairable (REP) system, wherein the defect repair information is generated by an inspection station which is sited behind the AOI device and determines that the target material is abnormal, and the defect repair information comprises defect location information and a defect location image. The data maintenance module is configured to integrate the optical inspection result and the control management data to generate an optical test data sheet. The image extraction module is configured to obtain a material image of the target material and extract a component location image from the material image based on the defect location information. The information integration module is configured to read material data of the target material from the optical test data sheet based on the defect location information, and integrate the material data, the defect repair information and the component location image to generate integration information of the target material, wherein the material data comprises the control management data. The information output module is configured to output the integration information.

To achieve the objective, the present invention discloses a method of integrating production line data as auxiliary data for abnormality analysis, include steps of: after the target material is passed through an AOI device disposed on the production line, obtaining an optical inspection result generated by the AOI device and control management data of the target material generated by control management systems on the production line; integrating the optical inspection result and the control management data to generate an optical test data sheet; obtaining defect repair information, by a REP system, wherein the defect repair information is generated by an inspection station which is sited behind the AOI device and determines that the target material is abnormal, and the defect repair information includes defect location information and a defect location image; reading material data of the target material from the optical test data sheet based on the defect location information, wherein the material data includes the control management data; obtaining a material image of the target material, and extracting a component location image from the material image based on the defect location information; integrating the material data, the defect repair information and the component location image to generate integration information of the target material; outputting the integration information.

According to the above-mentioned device and the method of the present invention, the difference between the present invention and the conventional technology is that, in the present invention, the REP system obtains the defect repair information generated by the inspection station sited behind the AOI device and determining that the target material is abnormal, the material data of the target material is read based on the defect location information from the optical test data sheet generated by integrating the optical inspection data generated by the AOI device and the control management data generated by the control management system on the production line, and the component location image is extracted from the material image of the target material based on the defect location information of the defect repair information, and the material data, the defect repair information and the component location image are integrated to generate the integration information of the target material, thereby solving the conventional problem, and achieving the technical effect of improving the efficiency of abnormal analysis on the production line.

### BRIEF DESCRIPTION OF THE DRAWINGS

The structure, operating principle and effects of the present invention will be described in detail by way of various embodiments which are illustrated in the accompanying drawings.

FIG. 1 is a schematic view of a device of integrating production line data as auxiliary data for abnormality analysis, according to the present invention.

FIG. 2 is a schematic view of a processor, according to the present invention.

FIG. 3A is a flowchart of a method of integrating production line data as auxiliary data for abnormality analysis, according to the present invention.

FIG. 3B is a flowchart of extracting a component location image from a material image, according to the present invention.

FIG. 3C is a flowchart of generating and outputting an abnormality determination result, according to the present invention.

FIG. 4 is a schematic view of integration information, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

The technical solution of the present invention integrates data generated by inspection stations on a production line to assist automated optical inspection (AOI) technicians in performing abnormal analysis and decision-making when abnormalities occur during the production process of target products on the production line. The inspection station described in the present invention can include, not limited to, an optical inspection station, an in-circuit testing (ICT) station, a functional block test (FBT) station, or an end of line inspection (EOLI) station.

The device for implementing the concept of the present invention can be a computing apparatus. The computing apparatus mentioned in the present invention can include, but not limited to, one or more processing module, one or more memory module, and a bus connected to different hardware components including the memory module and the processing module. Through the hardware components, the computing apparatus can load and execute the operating system, so that the operating system runs on the computing apparatus and executes software or programs. In addition, the computing apparatus can include an outer shell, and the above-mentioned hardware component are disposed in the outer shell.

The bus mentioned in the present invention can include at least one type of bus, for example, the bus can include at least one of a data bus, an address bus, a control bus, an expansion bus, and a local bus. The bus of a computation device can include, but not limited to, a parallel bus such as an industry standard architecture (ISA) bus, a peripheral component interconnect (PCI) bus, a video electronics standards association (VESA) local bus, or a serial bus such as a USB, or a PCI express (PCI-E/PCIe) bus.

The processing module of the computing apparatus is coupled with the bus. The processing module includes a register group or a register space. The register group or the register space can be completely set on the processing chip of the processing module, or can be all or partially set outside the processing chip and is coupled to the processing chip through dedicated electrical connection and/or a bus. The processing module can be a central processing unit, a microprocessor, or any suitable processing component. If the computing apparatus is a multi-processor apparatus, that is, the computing apparatus includes processing modules, and the processing modules can be all the same or similar, and coupled and communicated with each other through a bus. The processing module can interpret a computer instruction or a series of multiple computer instructions to perform specific operations or operations, such as mathematical operations, logical operations, data comparison, data copy/moving, to drive other hardware component, execute the operating system, or execute various programs and/or module in the computing apparatus. The computer instructions can include assembly language instructions, instruction set architecture instructions, machine instructions, machine-related instructions, microinstructions, firmware instructions, or source code or object code written in one or more programming languages. The instructions can be executed entirely on a single computing apparatus, partially on a single computing apparatus, or partially on one computing apparatus and partially on another interconnected computing apparatus. The above-mentioned programming language can be, for example, object-oriented languages such as Common Lisp, Python, C++, Objective-C, Smalltalk, Delphi, Java, Swift, C#, Perl, Ruby, as well as procedural languages like C or similar languages.

The computing apparatus usually also includes one or more chipsets. The processing module of the computing apparatus can be coupled to the chipset, or electrically connected to the chipset through the bus. The chipset includes one or more integrated circuits (IC) including a memory controller and a peripheral input/output (I/O) controller, that is, the memory controller and the peripheral input/output controller can be implemented by one integrated circuit or implemented by two or more integrated circuits. Chipsets usually provide I/O and memory management functions, and multiple general-purpose and/or dedicated-purpose registers, timers. The above-mentioned general-purpose and/or dedicated-purpose registers and timers can be coupled to or electrically connected to one or more processing modules to the chipset for being accessed or used. In an embodiment, the chipset can be a part of the processing module.

The processing module of the computing apparatus can also access the data stored in the memory module and mass storage area installed on the computing apparatus through the memory controller. The above-mentioned memory modules include any type of volatile memory and/or non-volatile memory (NVRAM), such as Static Random Access Memory (SRAM), Dynamic Random Access Memory (DRAM), Read-Only Memory (ROM), or Flash memory. The above-mentioned mass storage area can include any type of storage device or storage medium, such as hard disk drives, optical discs, flash drives, memory cards, and solid state disks (SSD), or any other storage device. In other words, the memory controller can access data stored in static random access memory, dynamic random access memory, flash memory, hard disk drives, and solid state drives.

The processing module of the computing apparatus can also connect and communicate with peripheral devices and interfaces including peripheral output devices, peripheral input devices, communication interfaces, or data/signal receivers through the peripheral I/O controller and the peripheral I/O bus. The peripheral input device can be any type of input device, such as a keyboard, mouse, trackball, touchpad, or joystick. The peripheral output device can be any type of output device, such as a display, or a printer; the peripheral input device and the peripheral output device can also be the same device such as a touch screen. The communication interface can include a wireless communication interface and/or a wired communication interface. The wireless communication interface can include the interface capable of supporting wireless local area networks (such as Wi-Fi, Zigbee, etc.), Bluetooth, infrared, and near-field communication (NFC), 3G/4G/5G and other mobile communication network (cellular network) or other wireless data transmission protocol; the wired communication interface can be an Ethernet device, a DSL modem, a cable modem, an asynchronous transfer mode (ATM) devices, or optical fiber communication interfaces and/or components. The data/signal receiver can include a GPS receiver or physiological signal receiver. The physiological signals received by the physiological signal receiver include, but are not limited to, heartbeat, blood oxygen levels, and so on. The processing module can periodically poll various peripheral devices and interfaces, so that the computing apparatus can input and output data through various peripheral devices and interfaces, and can also communicate with another computing apparatus having the above-mentioned hardware components.

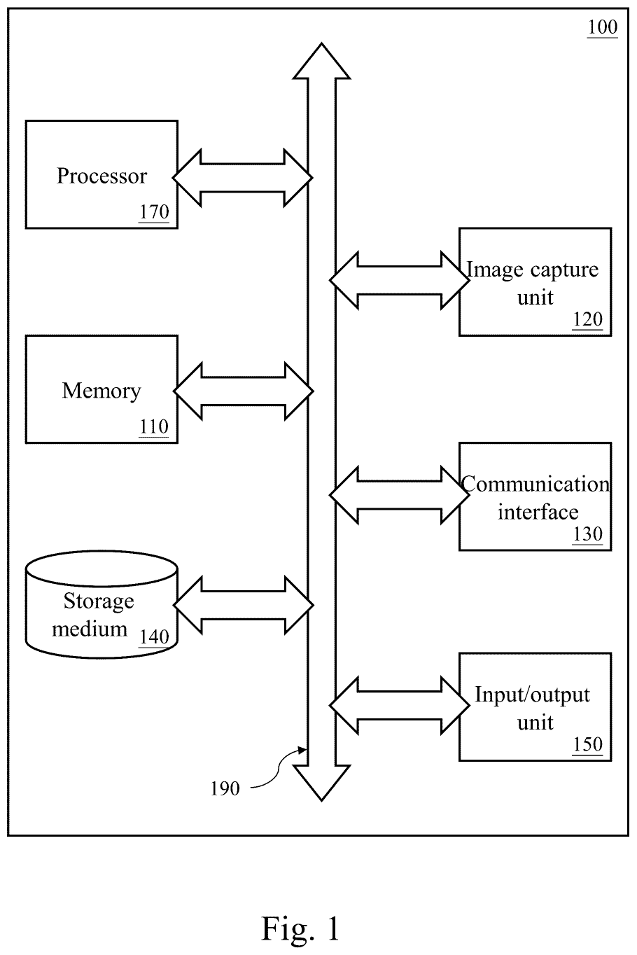

The implementation of the present invention is illustrated with reference to FIG. 1. FIG. 1 is a schematic view of the components of a device of integrating production line data as auxiliary data for abnormality analysis. As shown in FIG. 1, the device 100 of the present invention includes a memory 110, an image capture unit 120, a communication interface 130, a storage medium 140, an input/output unit 150, a processor 170, and a bus 190. The memory 110, the communication interface 130, the storage medium 140, and the processor 170 are connected through the bus 190 and interact with each other.

The memory 110 is configured to store one or more sets of computer instructions.

The image capture unit 120 includes a circuit board, a camera assembly, and an image sensor component (all not shown in FIG. 1). The camera assembly and the image sensor component are connected to each other through the circuit board. The image capture unit 120 captures images through the camera assembly and the image sensor component.

The communication interface 130 is connected to a network device such as an external network attached a storage device or a server, and requests and downloads data from the connected network device.

The storage medium 140 is configured to store data or signals downloaded through the communication interface 130, store data or signals provided to the processor 170 or needed by the processor 170 during operation, or store data or signals generated by the processor 170.

The input/output unit 150 is configured to provide input data through a peripheral input device of the device 100. For example, the input/output unit 150 can input data via a keyboard, a mouse, a touchpad, or a touch screen.

The input/output unit 150 can also output data generated by the processor 170 through a peripheral output device of the device 100. For example, the input/output unit 150 can display data via a monitor or a touch screen.

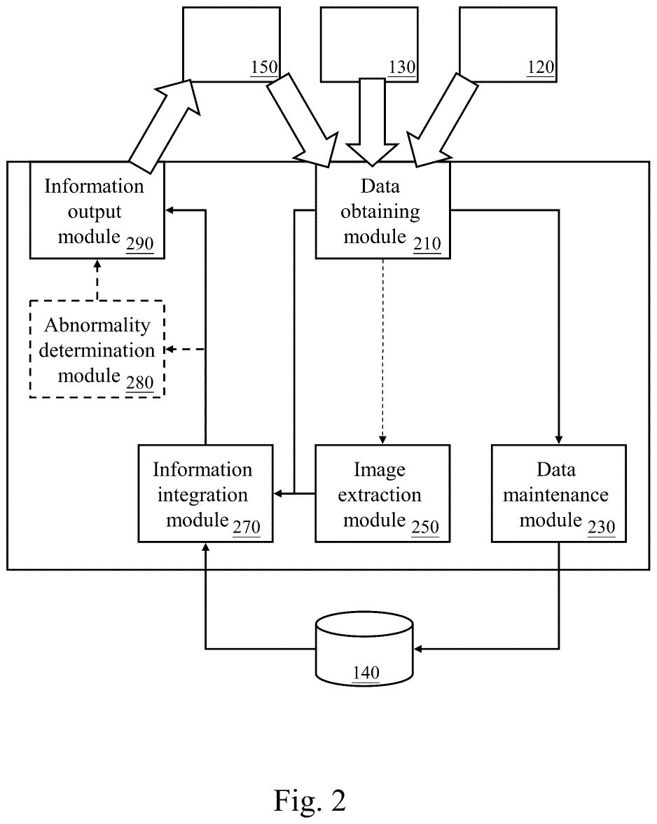

Please refer to FIG. 2. FIG. 2 is a schematic view of the modules proposed by the present invention. As shown in FIG. 2, the processor 170 includes a data obtaining module 210, a data maintenance module 230, an image extraction module 250, an information integration module 270, and an information output module 290. Optionally, the processor 170 can also include an abnormality determination module 280. In some embodiments, the processor 170 executes the computer instructions stored in the memory 110, and after executing the computer instructions, the modules shown in FIG. 2 can be generated. In another embodiments, the modules in FIG. 2 may be implemented by one or more circuits and/or fully or partially by chip-based hardware components. That is, the processor 170 includes hardware components forming the modules in FIG. 2. Therefore, the modules in the processor 170 can be either software modules or hardware modules without any limitation in the present invention.

After the target material is passed through the automated optical inspection (AOI) device set in the optical inspection station on the production line, the data obtaining module 210 obtains an optical inspection result generated by the AOI device on the production line and the control management data of the target material generated by one or more control management system. The optical inspection result obtained by the data obtaining module 210 includes an inspection data sheet, a material image and a test log of the target material, and the inspection data sheet includes the material identification data of the target material, the inspection data sheet also includes component identification data, inspection identification data, inspection locations, inspection times, and inspection results of various components on the target material. The control management systems described in the present invention can include, but not limited to, a factory information system (FIS), a manufacturing execution system (MES), or an integrated manufacturing data management system (IMDM).

The control management data obtained by the data obtaining module 210 corresponds to the control management system generating the control management data, for example, the control management data can include basic product information of the target material recorded by the factory information system during the production process, material binding information of the target material recorded by the manufacturing execution system, and apparatus status information of a surface-mounted-technology (SMT) apparatus during the SMT process of the target material, and material information of the target material recorded by the integrated manufacturing data management system. However, the present invention is not limited to these examples. In more detail, the basic product information recorded by the factory information system includes material identification data and test identification data of the target material, the basic product information includes a material type, the test identification data in the basic product information corresponds to the inspection identification data in the optical inspection result, and the material identification data in the basic product information corresponds to the optical inspection result; the material binding information recorded by the manufacturing execution system includes the material identification data of the target material, and a mounted location of the components mounted on the target material; the material identification data in the optical inspection result corresponds to the material binding information, and the inspection location in the optical inspection result corresponds to the mounted location in the material binding information; the material information recorded by the integrated manufacturing data management system includes various parameters and specifications of the target material. The material identification data of the target material in the material information corresponds to the component identification data in the optical inspection result.

The data obtaining module 210 obtains the defect repair information from the repair/repairable (REP) system on the production line. The data obtaining module 210 can be actively connected to the REP system at regular or fixed intervals to obtain the defect repair information, or the data obtaining module 210 can passively receive the defect repair information transmitted by the inspection station or the REP system. The present invention is not limited particularly to the above-mentioned examples.

The defect repair information obtained by the data obtaining module 210 is generated by an inspection station set behind the AOI device and determining the target material is abnormal. The defect repair information includes the material identification data, the defect location information, and the defect location image of the target material. The defect location information included in the defect repair information contains the location information (such as coordinates and ranges) of the abnormal component on the target material. However, the present invention is not limited to these examples. The material identification data in the optical inspection result corresponds to the defect repair information, and the defect location information in the defect repair information corresponds to the inspection location in the optical inspection result.

The data obtaining module 210 obtains, through the communication interface 130, the optical inspection result generated by the AOI device on the production line, the control management data of the target material generated by the control management system, and the defect repair information generated by the inspection station and provided to the REP system. For example, the data obtaining module 210 can be connected to the AOI device, the control management system, the inspection station, or the REP system on the production line to download the optical inspection result, the control management data, or the defect repair information. Alternatively, the data obtaining module 210 can read the optical inspection result, control management data, or defect repair information stored in the storage medium 140 in advance.

The data obtaining module 210 also obtains the material image of the target material. Generally, the data obtaining module 210 can read the material image from the optical inspection result stored in the storage medium 140, or the data obtaining module 210 can obtain the material image from the optical inspection result downloaded by the AOI device via the communication interface 130, or extract the material image from the production line using the image capture unit 120. The material image includes a complete image of the target material, but the present invention is not limited to these examples.

The data maintenance module 230 integrates the optical inspection result obtained by the data obtaining module 210 with various control management data to generate an optical test data sheet. Generally, the data maintenance module 230 generates the optical test data sheet based on a correspondence relationship between the material identification data, the component identification data, and the inspection identification data of the target material in the optical inspection result and the various control management data. In the present invention, each piece of data in the optical test data sheet is also referred to as material data.

The image extraction module 250 extracts the component location image of the component determined as abnormal from the material image obtained by the data obtaining module 210 based on the defect location information in the defect repair information obtained by the data obtaining module 210. The component location image extracted by the image extraction module 250 includes the component determined as abnormal.

In an embodiment, when the coordinate system used by the material image and the defect location information differs from each other, the image extraction module 250 can convert the coordinates in the defect location information to a pixel location coordinate corresponding to the material image, and extract the component location image from the material image based on the pixel location coordinate. For example, the image extraction module 250 can map the coordinates in the defect location information to the material image to generate the corresponding pixel location coordinate based on, for example, scaling parameters, rotation angles, or origin locations in the defect repair information; however, the present invention is not limited to these examples.

The information integration module 270 reads the material data of the target material from the optical test data sheet created by the data maintenance module 230, based on the defect location information obtained by the data obtaining module 210; for example, the information integration module 270 searches for matching material data in the component inspection location field in the optical test data sheet based on the coordinates in the defect location information. The material data read by the information integration module 270 includes the control management data of the target material.

The information integration module 270 integrates the material data, the defect repair information obtained by the data obtaining module 210, and the component location image generated by the image extraction module 250 to generate the integration information of the target material, that is, the information integration module 270 integrates the material data, the defect repair information, and the component location image based on the correspondence relationships between the material identification data, the component identification data, the inspection identification data, and the component inspection field contained in the material data and the defect repair information. Generally, the information integration module 270 generates the integration information in a data sheet format, but the present invention is not limited to the example.

The abnormality determination module 280 generates an abnormality determination result based on the integration information generated by the information integration module 270.

The information output module 290 is configured to output the integration information generated by the information integration module 270. Generally, the information output module 290 provides the integration information to the input/output unit 150, so that the integration information can be outputted through the input/output unit 150 via display, printing, or other methods, but the present invention is not limited to these examples. In some embodiments, the information output module 290 provides the simplified form of the target material to the input/output unit 150 for display, and when the simplified form is selected, the information output module 290 can further provide the complete integration information to the input/output unit 150 for display. However, the present invention is also not limited to this example.

The information output module 290 can output the abnormality determination result generated by the abnormality determination module 280; for example, the information output module 290 can provide the abnormality determination result to the input/output unit 150, so that the abnormality determination result can be outputted via the input/output unit 150.

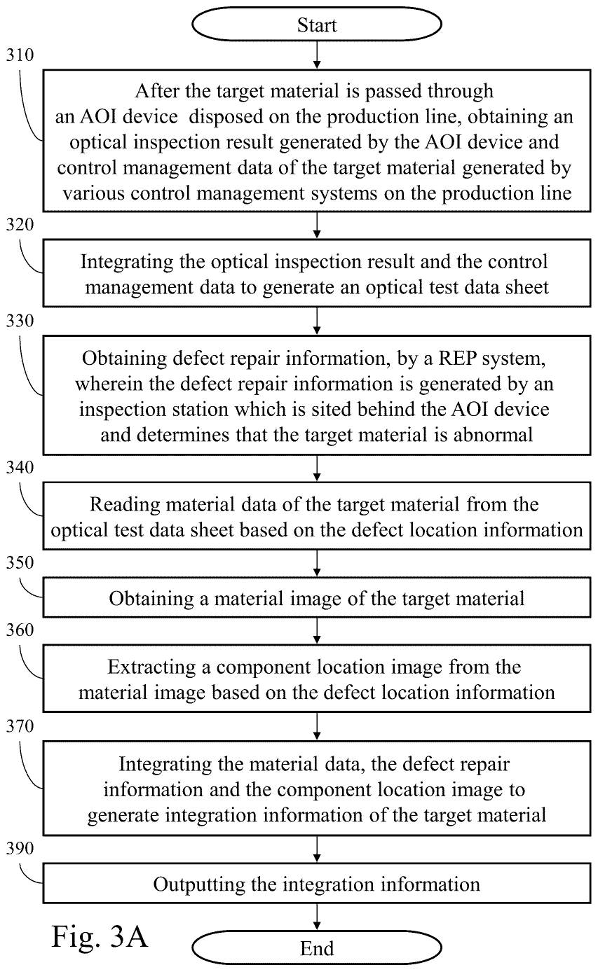

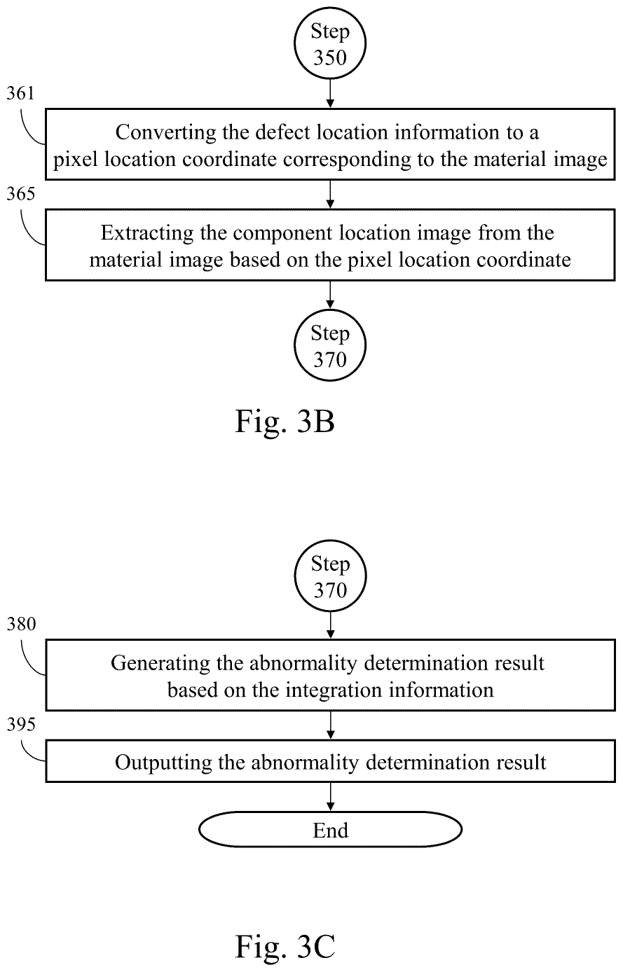

An embodiment is provided to explain the operations and method of the system in the present invention. Please refer to FIG. 3A. FIG. 3A is a flowchart of a method of integrating production line data as auxiliary data for abnormality analysis according to the present invention. In this embodiment, a device 100 is disposed on a production line, the target material is a motherboard, but the present invention is not limited to these examples.

In a step 310, after the target material is passed through an AOI device disposed on the production line, the data obtaining module 210 of the device 100 obtains an optical inspection result generated by the AOI device and control management data of the target material generated by various control management systems on the production line. In this embodiment, the AOI device is a solder paste inspection (SPI) device, the control management systems comprise the factory information system, the manufacturing execution system and the integrated manufacturing data management system, and the control management data includes a material type of the target material obtained by the factory information system, material identification data of the target material and an apparatus status of a SMT apparatus obtained by the manufacturing execution system, and material information of the target material obtained by the integrated manufacturing data management system.

In a step 320, after the data obtaining module 210 of the device 100 obtains the optical inspection result and the control management data, the data maintenance module 230 of the device 100 integrates the optical inspection result and the control management data to generate an optical test data sheet. In this embodiment, the data maintenance module 230 can combine the optical inspection result with the control management data (such as basic product information, material binding information, material information) to form a single piece of material data based on a correspondence relationship between test identification data in the basic product information and the inspection identification data in the optical inspection result, a correspondence relationship between the material identification data in the optical inspection result and the material identification data in the basic product information, a correspondence relationship between the material identification data in the material binding information and the material identification data in the optical inspection result, a correspondence relationship between an inspection location in the optical inspection result and a SMT location in material binding information, and a correspondence relationship between the material identification data in the material information and the component identification data in the optical inspection result. The data maintenance module 230 then adds the generated material data to the optical test data sheet.

In a step 330, when the target material is moved along the production line and into the inspection station located behind the AOI device, when the inspection station determines that the target material is abnormal, the inspection station generates defect repair information and sends the defect repair information to the REP system on the production line, the data obtaining module 210 of the device 100 obtains the defect repair information generated by the inspection station. In this embodiment, the inspection station can be a circuit test station, a functional block test station, or an end-of-line test station. The data obtaining module 210 can be connected to the inspection station or the REP system to obtain the defect repair information of the target material.

In a step 340, after the data obtaining module 210 of the device 100 obtains the defect repair information of the target material, the data obtaining module 210 of the device 100 obtains the defect location information (and the material identification data) of the target material contained in the defect repair information, and reads the material data of the target material from the optical test data sheet created and maintained by the data maintenance module 230 of the device 100 based on the obtained defect location information (and the material identification data). In this embodiment, when the optical test data sheet is stored in the storage medium 140 of the device 100, the image extraction module 250 can read the material data of the target material from the storage medium 140 based on the material identification data in the target material, when the optical test data sheet is stored in an external network device outside the device 100, the image extraction module 250 can transmit the material identification data of the target material to the network device through the communication interface 130 and receive the material data of the target material returned by the external network device.

In a step 350, after the data obtaining module 210 of the device 100 obtains the defect repair information of the target material, the data obtaining module 210 of the device 100 obtains the material image of the target material. In this embodiment, when the data obtaining module 210 downloads the material image from the AOI device through the communication interface 130 of the device 100, the data obtaining module 210 can also read the material image from the material data stored in the storage medium 140 of the device 100.

In a step 360, after the data obtaining module 210 of the device 100 obtains the material image of the target material, the image extraction module 250 extracts the component location image from the material image based on the defect location information contained in the defect repair information. In this embodiment, the image extraction module 250 can determine whether a coordinate system of the defect location information is consistent with that of the material image, if yes, the image extraction module 250 directly extracts the component location image from the material image based on the coordinate system of defect location information; otherwise, as shown in the flowchart of FIG. 3B, in a step 361, the image extraction module 250 can first convert the defect location information to a pixel location coordinate corresponding to the material image; next, in a step 365, the image extraction module 250 can extract the component location image from the material image based on the pixel location coordinate generated by the conversion process.

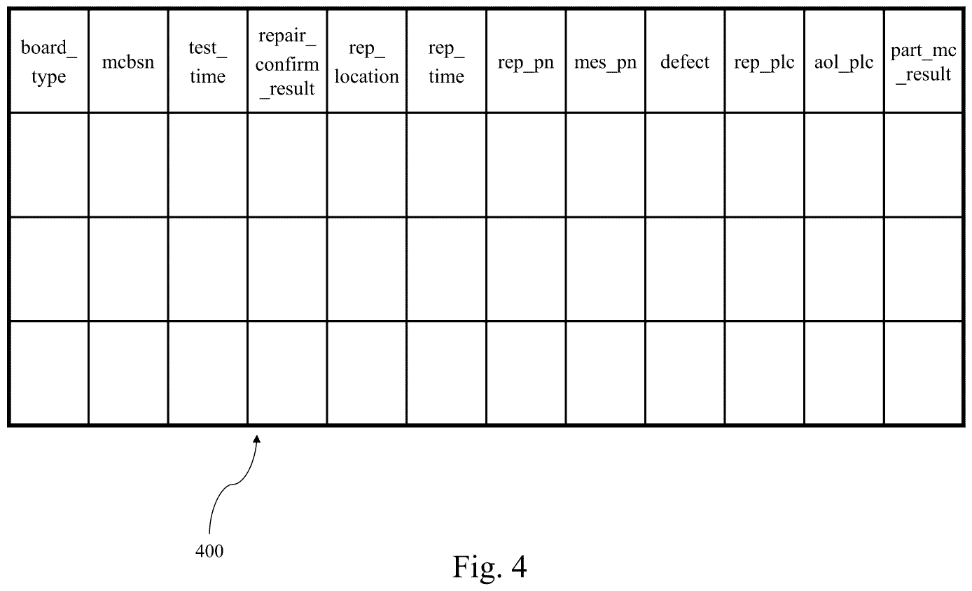

Please refer to FIG. 3A. In a step 370, after the image extraction module 250 of the device 100 obtains the component location image, the information integration module 270 of the device 100 integrates the material data and the defect repair information obtained by the data obtaining module 210 of the device 100 with the component location image obtained by the image extraction module 250 to generate the integration information of the target material. In a step 390, the information output module 290 outputs the integration information generated by the information integration module 270. In this embodiment, when the information output module 290 outputs the integration information 400 (as shown in FIG. 4) through the input/output unit 150 of the device 100, the integration information 400 can include data fields having the material type (board_type) of the target material obtained by the factory information system, the material identification data (mcbsn), the inspection time (test_time), the inspection result (part_mc_result), the inspection confirmation result (repair_confirm_result) and the inspected component image (aol_plc) generated by the AOI device, the defect location information (rep_location), the defect type (defect), the inspection time (rep_time), the repair identification data (rep_pn), the component location image (rep_plc) generated by the inspection station, and the material identification data (mes_pn) of the target material obtained by the manufacturing execution system. Moreover, when the repair identification data generated by the inspection station or the material identification data of the target material obtained by the manufacturing execution system is selected, the information output module 290 outputs the material information of the target material obtained by the integrated manufacturing data management system through the input/output unit 150 of the device 100.

According to above-mentioned solution of the present invention, the data generated by various inspection stations along the production line can be integrated to provide an abnormality analysis report.

In the above embodiment, in a step 380, when the device 100 includes the abnormality determination module 280, as shown in the flowchart of FIG. 3C, after the information integration module 270 of the device 100 generates integration information of the target material (the step 370), the abnormality determination module 280 generates the abnormality determination result based on the integration information generated by the information integration module 270 (the step 380); in a step 395, when outputting the integration information through the input/output unit 150 of the device 100 (the step 390), the information output module 290 of the device 100 can output the abnormality determination result.

According to above-mentioned contents, the difference between the present invention and the conventional technology is that, in the present invention, the REP system obtains the defect repair information generated by the inspection station sited behind the AOI device and determining that the target material is abnormal, the material data of the target material is read based on the defect location information from the optical test data sheet generated by integrating the optical inspection data generated by the AOI device and the control management data generated by the control management systems on the production line, and the component location image is extracted from the material image of the target material based on the defect location information of the defect repair information, and the material data, the defect repair information and the component location image are integrated to generate the integration information of the target material, thereby solving the conventional problem that the abnormality tracing and locating operation on the production line being limited by the personal experience of test engineers and the independent use of data from inspection station may lead to errors in judgment, and achieving the technical effect of improving the efficiency of abnormal analysis on the production line.

Furthermore, the above-mentioned method of integrating production line data as auxiliary data for abnormality analysis can be implemented by hardware, software or a combination thereof, and can be implemented in a computer system by a centralization manner, or by a distribution manner of different components distributed in several interconnected computer systems.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A method of integrating production line data as auxiliary data for abnormality analysis, wherein the method is applied to a device or a system, the device or the system is disposed in or applied to a production line of a target material, and the method comprises:
after the target material is passed through an automated optical inspection (AOI) device disposed on the production line, obtaining an optical inspection result generated by the AOI device and control management data of the target material generated by control management systems on the production line;
integrating the optical inspection result and the control management data to generate an optical test data sheet;
obtaining defect repair information, by a repair/repairable system, wherein the defect repair information is generated by an inspection station which is sited behind the AOI device and determines that the target material is abnormal, and the defect repair information comprises defect location information and a defect location image;
reading material data of the target material from the optical test data sheet based on the defect location information, wherein the material data comprises the control management data;
obtaining a material image of the target material, and extracting a component location image from the material image based on the defect location information;
integrating the material data, the defect repair information and the component location image to generate integration information of the target material; and
outputting the integration information.

2. The method of integrating production line data as auxiliary data for abnormality analysis according to claim 1, wherein after the step of generating the integration information of the target material, further comprising:
generating an abnormality determination result based on the integration information, and outputting the abnormality determination result.

3. The method of integrating production line data as auxiliary data for abnormality analysis according to claim 1, wherein the step of obtaining the material image of the target material comprises:
reading the material image from the optical inspection result or downloading the material image from the AOI device.

4. The method of integrating production line data as auxiliary data for abnormality analysis according to claim 1, wherein the control management systems comprise at least one of a factory information system, a manufacturing execution system, and an integrated manufacturing data management system, and the control management data comprises at least one of material identification data, an inspection time and an inspection result of the target material generated by the AOI device, a material type of the target material obtained by the factory information system, the material identification data of the target material and an apparatus status of a surface mounted technology apparatus obtained by the manufacturing execution system, and material information of the target material obtained by the integrated manufacturing data management system.

5. The method of integrating production line data as auxiliary data for abnormality analysis according to claim 1, wherein the step of extracting the component location image from the material image based on the defect location information, comprises:
converting the defect location information into a pixel location coordinate corresponding to the material image, and extracting the component location image from the material image based on the pixel location coordinate.

6. A device of integrating production line data as auxiliary data for abnormality analysis, comprising:
a memory, configured to store at least one computer instruction; and
a processor, connected to the memory and configured to execute the at least one computer instruction to generate:
a data obtaining module, wherein after a target material is passed through an automated optical inspection (AOI) device disposed on a production line, the data obtaining module is configured to obtain an optical inspection result generated by the AOI device and control management data of the target material generated by control management systems on the production line, and obtain defect repair information through a repair/repairable system, wherein the defect repair information is generated by an inspection station which is sited behind the AOI device and determines that the target material is abnormal, and the defect repair information comprises defect location information and a defect location image;
a data maintenance module, configured to integrate the optical inspection result and the control management data to generate an optical test data sheet;
an image extraction module, configured to obtain a material image of the target material, and extract a component location image from the material image based on the defect location information;
an information integration module, configured to read material data of the target material from the optical test data sheet based on the defect location information, and integrate the material data, the defect repair information and the component location image to generate integration information of the target material, wherein the material data comprises the control management data; and
an information output module, configured to output the integration information.

7. The device of integrating production line data as auxiliary data for abnormality analysis according to claim 6, wherein the processor further generates an abnormality determination module configured to generate an abnormality determination result based on the integration information, wherein the information output module is configured to output the abnormality determination result.

8. The device of integrating production line data as auxiliary data for abnormality analysis according to claim 6, wherein the image extraction module reads the material image from the optical inspection result or the data obtaining module obtains the material image from the data downloaded from the AOI device.

9. The device of integrating production line data as auxiliary data for abnormality analysis according to claim 6, wherein the control management data comprises at least one of material identification data, an inspection time and an inspection result of the target material generated by the AOI device, a material type of the target material obtained by a factory information system, the material identification data of the target material and an apparatus status of a surface mounted technology apparatus obtained by a manufacturing execution system, and material information of the target material obtained by an integrated manufacturing data management system, wherein the control management system comprises the factory information system, the manufacturing execution system and the integrated manufacturing data management system.

10. The device of integrating production line data as auxiliary data for abnormality analysis according to claim 6, wherein the image extraction module converts the defect location information into a pixel location coordinate corresponding to the material image and extracts the component location image from the material image based on the pixel location coordinate.
